(19) United States
(12) Patent Application Publication
(10) Pub. No.: US 2018/0267757 A1
(43) Pub. Date: Sep. 20, 2018

(54) SYSTEM AND METHOD FOR INTERACTING WITH MEDIA DISPLAYS

(71) Applicant: Edo Segal, New York, NY (US)

(72) Inventor: Edo Segal, New York, NY (US)

(21) Appl. No.: 15/462,740

(22) Filed: Mar. 17, 2017

(51) Int. Cl. G06F 3/147; H04W 4/02; G06F 3/0354; G06F 3/038

(52) U.S. Cl. CPC G06F 3/147; H04W 4/02; G06F 2203/0384; G06F 3/03542; G06F 3/038; G06F 3/03545

(57) ABSTRACT

Displaying content on an electronic display device is disclosed. An electronic display device is configured to display content received directly or indirectly from a computing device. A wireless output device IS configured to emit light signals and sound signals in response to an actuation of the wireless output device. Further, a sensor component is configured to receive the light signals and the audio signals, and a communications module communicates with the computing device. The light signals and sound signals from the wireless output device are received by the sensor component and usable to determine a respective location of the wireless output device relative to output of the electronic display device. The computing device uses the respective location to generate output received by the electronic display device to simulate the wireless output device operating as a writing device as a function of the generated output.

### FIELD

The present application relates, generally, to devices, methods and systems for interacting with media displays, and, more particularly, to devices, systems and methods for providing interactive hardware for providing display data to a non-interactive display.

### BACKGROUND

Collaborative and interactive work spaces have been made available to remote workers through software that allows for screen sharing and collaborative editing of documents. For instance, a manager can provide an on-line platform for collaborative real-time document editing. In these implementations and those like it, each participant must use a computer or tablet device, and access the collaborative platform and collaborate.

One drawback of the current collaboration systems is that they fail to replicate one of the most common ways to generate collaborative work product, collaboration before a white board. When groups use the white board, they are able to sketch ideas, identify links between concepts and manipulate data in an intuitive, natural way.

Present collaborative systems implement the collaborations within a digital space on a small computer screen. Each user, including those currently directing the collaborative work effort, are confined to direct their attention to the user interface to record their ideas. Additionally, the participants of the collaborative session are grouped around one or more computers and are not able to interact in a group dynamic. As a result, the spontaneity or dynamisms of collaborating before a black board or white board is lost.

It is with respect to these and other considerations that the disclosure made herein is presented.

### SUMMARY

In one or more implementations, the present application provides a system and method for displaying content on an electronic display device. A computing device having at least one processor is configured by executing code stored on non-transitory processor readable media. An electronic display device is configured to display content received directly or indirectly from the computing device. A wireless output device is configured to emit light signals and sound signals in response to an actuation of the wireless output device. Further, a sensor component is configured with a light receptor to receive the light signals, a sound receptor to receive the audio signals, and a communications module configured to communicate with the computing device. The light signals and sound signals from the wireless output device are received by the sensor component and usable to determine a respective location of the wireless output device relative to output of the electronic display device. The computing device uses the respective location to generate output received by the electronic display device to simulate the wireless output device operating as a writing device as a function of the generated output.

### BRIEF DESCRIPTION OF THE DRAWINGS

Further aspects of the present disclosure will be more readily appreciated upon review of the detailed description of its various implementations, described below, when taken in conjunction with the accompanying drawings, of which:

FIG. 1 is a diagram illustrating an example hardware arrangement providing the systems and methods disclosed herein;

FIGS. 2A and 2B illustrate use of components of the present application in accordance with an example implementation;

FIG. 3 is a top view of an example virtual marker, in accordance with an example implementation of the present application;

FIG. 4 is a simplified schematic drawing of the stylus portion of an example virtual marker, in accordance with an example implementation of the present application;

FIG. 5 illustrates actuation of the tip portion of an example virtual marker, in accordance with an example implementation of the present application;

FIG. 6 is a circuit diagram illustrating an example function selector, in accordance with an implementation;

FIG. 7 is a circuit diagram illustrating components within an example virtual marker, in accordance with an example implementation of the present application;

FIG. 8 illustrates a virtual marker placed within contactless or wireless charging station , in accordance with an example implementation of the present application;

FIG. 9 illustrates an example graphical user interface provided to display device 104 in accordance with an example implementation; and

FIGS. 10-12 are flow diagrams illustrate a broad aspects of method for performing operations in accordance with at least one implementation herein.

### DETAILED DESCRIPTION OF IMPLEMENTATIONS

By way of overview and introduction, the present application includes components in a system and method for simple to use and intuitive collaboration. In one or more implementations, a wireless output device (referred herein, generally, as a “virtual marker”) is formatted in the shape of a writing implement and configured to output sound and light signals while in use, as opposed to a traditional writing tool that deposits, for example, inorganic, organic or special pigment on a substrate. In operation, a user “writes” by pressing the stylus portion of the virtual marker in direct contact with a display device, such as a television or computer monitor, to depress the stylus portion into the virtual marker, thereby causing the virtual marker to emit the sound and light signals. The virtual marker can be configured with a rechargeable battery to provide a power source for the sound and light emitting components.

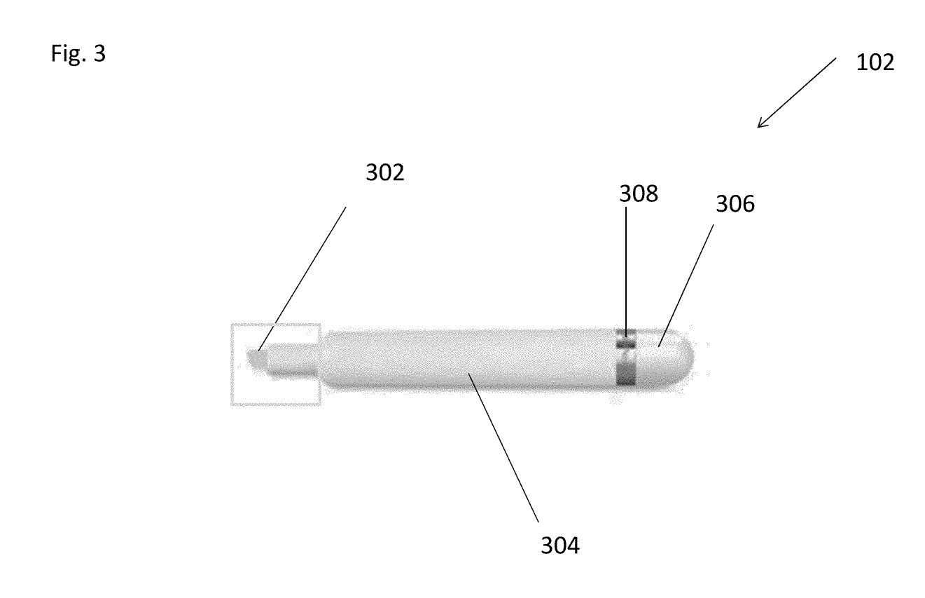

Although many of the examples and implementations shown and described herein provide the virtual marker as an output device, exclusively, the application is not so limited. In one or more implementations, the virtual marker can be configured with various components, such as a microprocessor, storage memory, a communications module, a location module, a camera, or other components. For example, a processor provided with the virtual marker can be configured by code executing therein to receive data from one or more input sensors, such as of a pressure sensitive type and capable of detecting levels of pressure exerted at a movable tip which extends from the distal end of the virtual marker. In addition (or in the alternative), and as show and described in greater detail herein, the tip portion of the virtual marker is capable of moving in and out of at least a portion of the inner circumference of the stylus housing (FIG. 3), upon exertion of pressure at the tip. As the tip is pressed into the stylus housing, input sensors can sense the amount of pressure and configure light and/or sound signals proportional to the applied contact pressure. Many of the examples and implementations shown and described herein regard a more simple construction that does not include all of these features, largely to portray an implementation providing significant cost savings over more complex constructions that include other components, such as identified described above.

In one or more implementations of the present application, the audio and light signals emitted by the virtual marker are received by a sensor component and processed to convert the signals to coordinates representing a relative location of the tip of the output device on the display device. The coordinates or, alternatively, representations of the audio and light signals are transmitted to a computing device (e.g., a mobile computing device) that is communicatively coupled, such as wirelessly, to the sensor component. For example, the sensor component can be configured with BLUETOOTH, Wi-Fi or other wireless connectivity, to transmit to the computing device. In operation, the coordinates are usable in one or more software applications operating on the computing device to provide output (e.g., video output) to the display device. In one or more implementations, video output to the display device at least partially represents the “writing” of the output device. As a user traverses the tip or stylus of the virtual marker on the display device at respective positions, lines are displayed on the display device at the respective positions substantially in real-time. Images of the output can be maintained, such as in storable data files in the computing device or in remote storage (e.g., in cloud-based storage), for future access.

As used herein, a “display device” represents an output device configured to present information in a visual form. A display device may be of several types, such as cathode ray tube (“CRT”), light emitting diode (“LED”) backlit, liquid crystal display (“LCD”), plasma, or any one of a plurality of projection display devices.

In one or more implementations, one or more software applications operating on the computing device can provide functionality in connection with information associated with the respective coordinates as the marker traverses an area on the display device. For example, optical character recognition functionality can be provided for converting a user's writings to machine-encoded text. Other functionality can include live, real-time sharing and conferencing capability.

Thus, the present application can leverage technology configured within the virtual marker, e.g., light and sound emitters, sensor component and computing device to provide a new form of live and interactive functionality that can make any output display conform into a high end video conferencing suite complete with interactive whiteboard.

In one or more implementations, use of a display, such as a monitor, television or other display output device, can be implemented in the present application in various ways, such as via an Internet media extender provided by APPLE TV, ROKU, AMAZON FIRE TV or GOOGLE CHROMECAST. As used herein, an Internet media extender refers, generally, to a category of devices that provide for content to be streamed to a home theater (e.g., television, surround sound devices, and the like.). The content can be provided from a remote source, such as a computing device and/or through one or more virtual markers that incorporates, or additionally includes, a camera and/or microphone located remotely and communicating over the Internet. The present application facilitates integrating the input capabilities of the virtual marker so as to allow a simulation of directly imputing information or data onto the display device of a home theater (e.g., television) using combination of components shown and described herein.

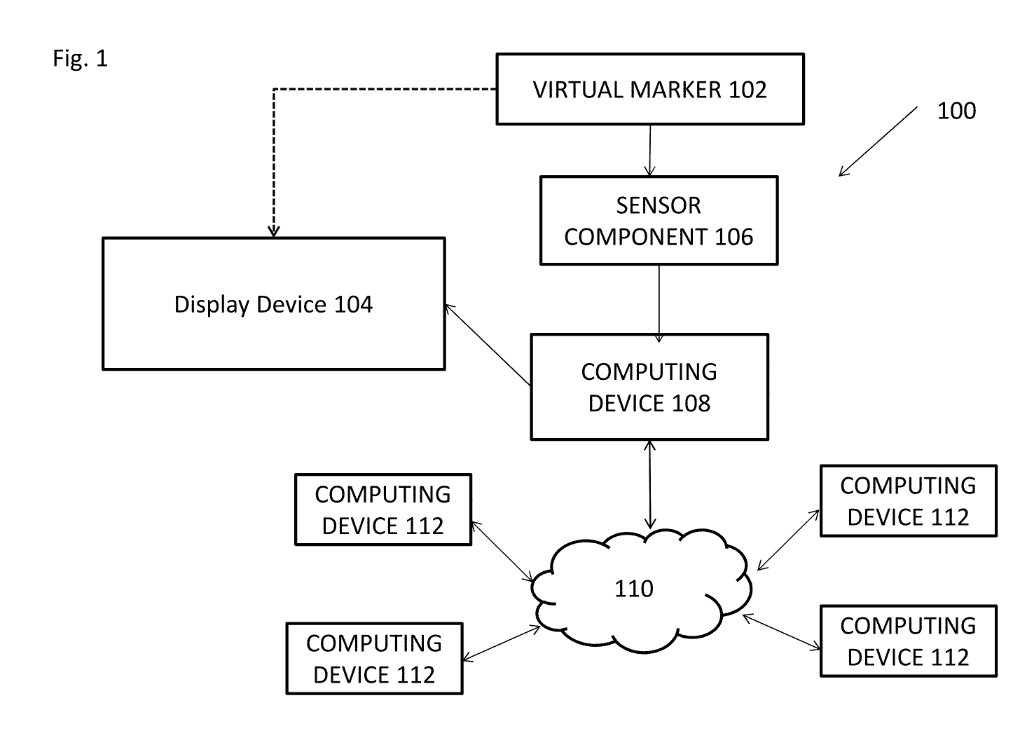

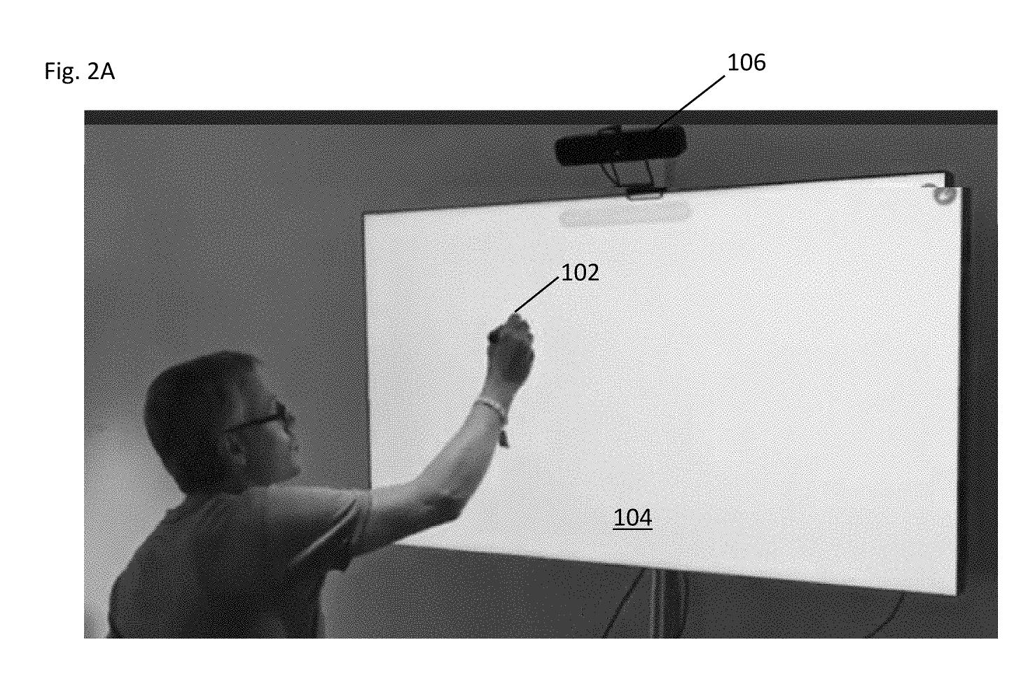

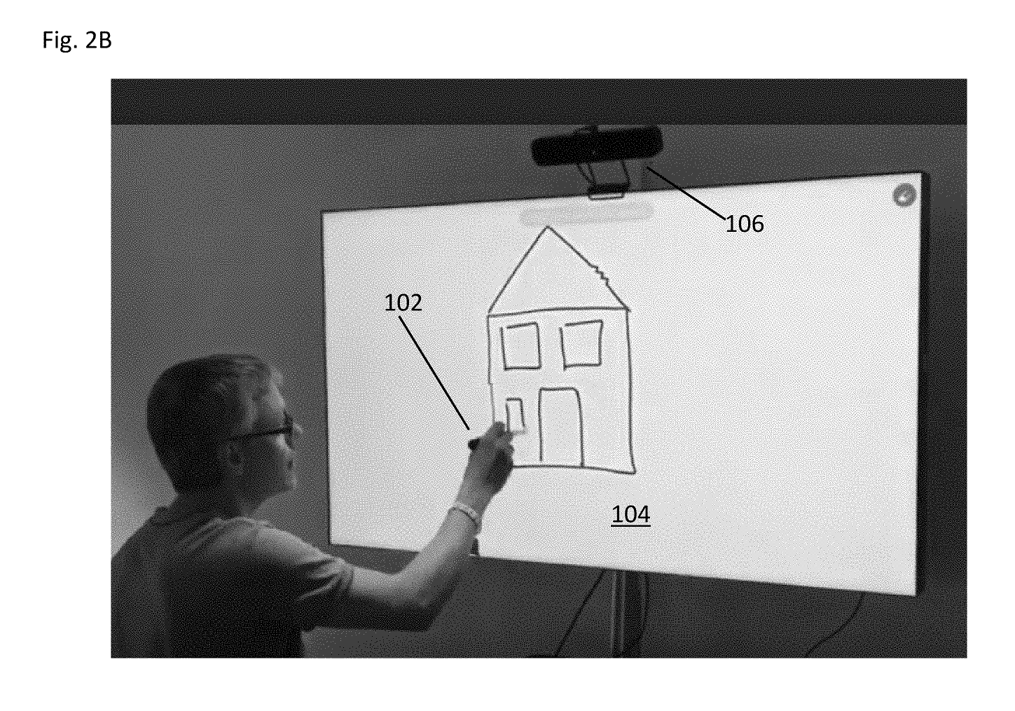

Referring to FIG. 1, a diagram is provided of an example hardware arrangement that operates for providing the systems and methods disclosed herein, and designated generally as system 100. System 100 can include virtual marker 102 that outputs light and sound signals as the virtual marker 102 traverses display device 104. The light and sound signals are sensed by a sensory component 106 that is at least communicatively coupled to one or more computing devices 108 across communication channel or network as indicated by solid line. For example, ultrasonic signals and infrared light signals are output by the virtual marker 102 when the tip or stylus portion of the virtual marker is depressed, thereby engaging a switch and causing the light and sound to be emitted by respective modules configured with the virtual marker 102. The user presses the tip or stylus of the virtual marker 102 on the display device 104, to “write” on the display device 104, which causes ultrasonic and infrared signals to be emitted and received by the sensor component 106. The computing device 108 in turn uses the coordinate information provided by the sensor component 106 to update the information displayed on the display device 108. In one particular implementation, the computing device 108 processes the coordinate information and outputs video to the display device 104. In addition, the computing device 108 can output video and/or data to data communication network 110 (e.g., the Internet) and devices 112 connected thereto receive the video and/or data over network 110. Thus, through a connection to a local or remote network, computing device 108 can transmit video and/or data generated as a function of coordinates directly and/or indirectly received from sensor component 106, for providing a substantially real-time display of the “writing” of the virtual marker 102 on display device 104. An example of a person drawing a picture of a house on an output display device 104 using virtual marker 102 is illustrated in FIGS. 2A and 2B.

Computing devices 108 can have the ability to send and receive data wireles sly, such as across a communication network, and be equipped with web browser(s), software applications, or other means, to provide received data on devices. By way of example, computing device 108 may be a smartphone or other mobile computing device, a media extender, a personal computer or a tablet, but not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network, and that wireless communication can be provided between wireless devices and data processing apparatuses (e.g., servers). In addition, system 100 can include a computing device 108 that is communicatively coupled to display device 104, such as directly or indirectly via a high-definition multimedia interface (“HDMI”) or other wired or wireless connection.

As shown in a particular and non-limiting example in FIG. 3, the virtual marker 102 is equipped with a stylus portion 302, a stylus housing 304 and a stylus end 306. In addition, virtual marker 102 is configured with a function selector 308, described in greater detail herein, which is usable to select alternative functionality, such as to select a different color, brush shape, point size or the like. In the illustrated arrangement, the virtual marker 102 has a marker or writing implement form factor. However, those possessing an ordinary and requisite level of skill in the art will appreciate that other form factors or configurations are envisioned and possible.

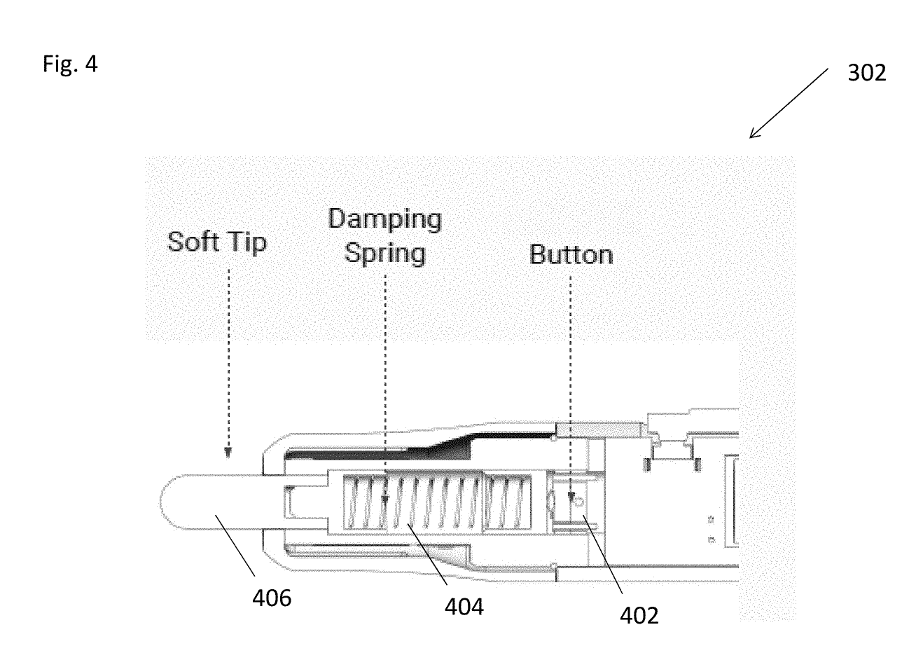

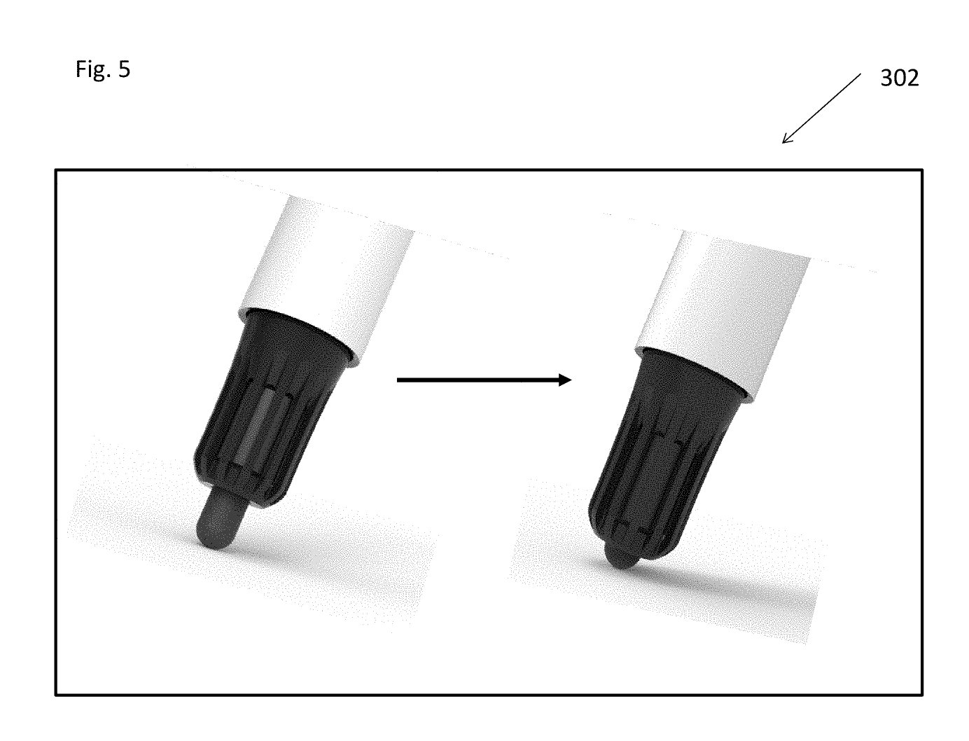

FIG. 4 is a simplified schematic drawing of the stylus portion 302 of an example virtual marker 102. Included in the portion 302 is pushbutton 402 that activates a switch to emit sound and light signals. In one or more implementations, pushbutton 402 has a working force of 10gF, which is very low and achieved by using a console contact plate that functions as a contact bridge between two pads. Together with soft damping spring 404, in operation the tip 406 imparts virtually no pressure on display device 106, even when depressed and causing pushbutton 402 to activate. The tip 406 is configured with a soft material, such as felt or microfiber cloth, to reduce pressure and protect the screen of the display device 104 from scratching. The damping spring 404 can function to return the tip portion 406 to its initial (outward) position, as well as to create a longer stroke for the tip portion 406, thereby improving the comfort of use of the virtual marker 102. The actuation of tip portion 406 further illustrated in FIG. 5.

As noted herein, the virtual marker 102 can be configured with a function selector 308, which can include a selection mechanism and indicators for the user of the virtual marker 102. For example, a function selector 308 can be used to control the color of a simulated line drawn by the virtual marker 102. In addition, a user can turn, tap or otherwise transmit commands via the virtual marker 102 to control other properties, such as line thickness, style, (e.g. dotted, dashed) and brush type simulated by the virtual marker 102. Furthermore, a visual or audio indicator can be provided that allows for the user to know in advance a particular setting of the virtual marker 102. For example, a LED or other light changing device is provided to give a visual indication of the type of functionality exhibited by the virtual marker 102. As an additional function, the user virtual marker 102 can be used as an eraser, thereby generating data indicating a location on the screen to delete content. In one or more implementations, the frequency and/or rate of infrared light signals emitted by the virtual marker 102 can be set to represent one or more settings of the function selector 308. For example, infrared light pulses at 30 milliseconds (ms) represents one color (e.g., blue), while at 40 ms a different color (e.g., red) is represented. Other customization can be similarly provided as a function of the frequency of light pulses.

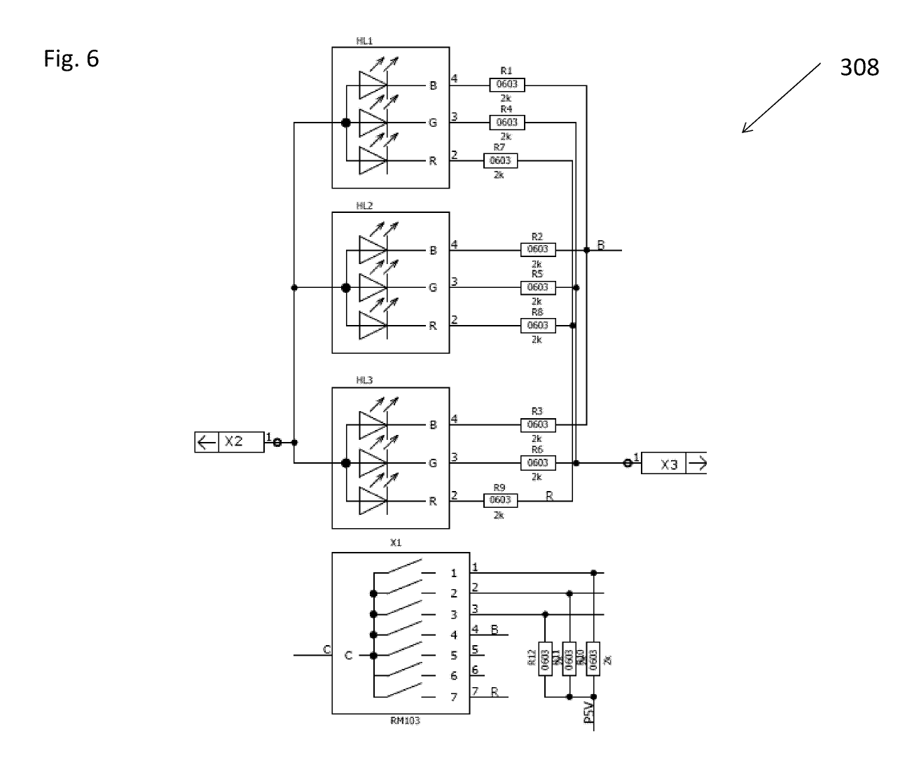

FIG. 6 is a circuit diagram illustrating an example function selector 308, in accordance with an implementation.

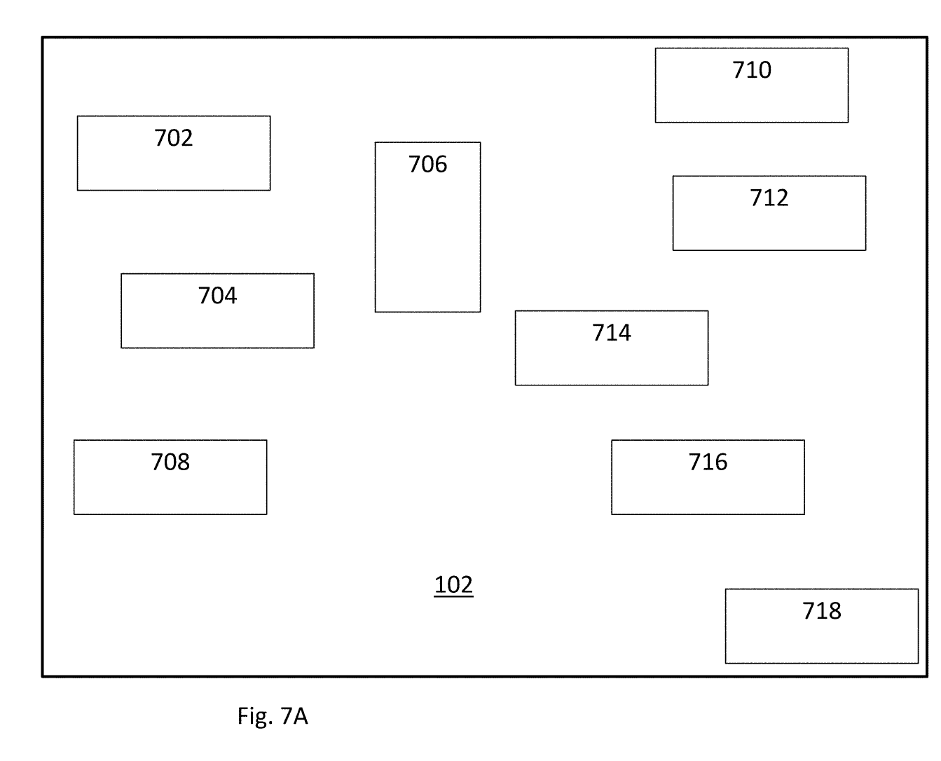

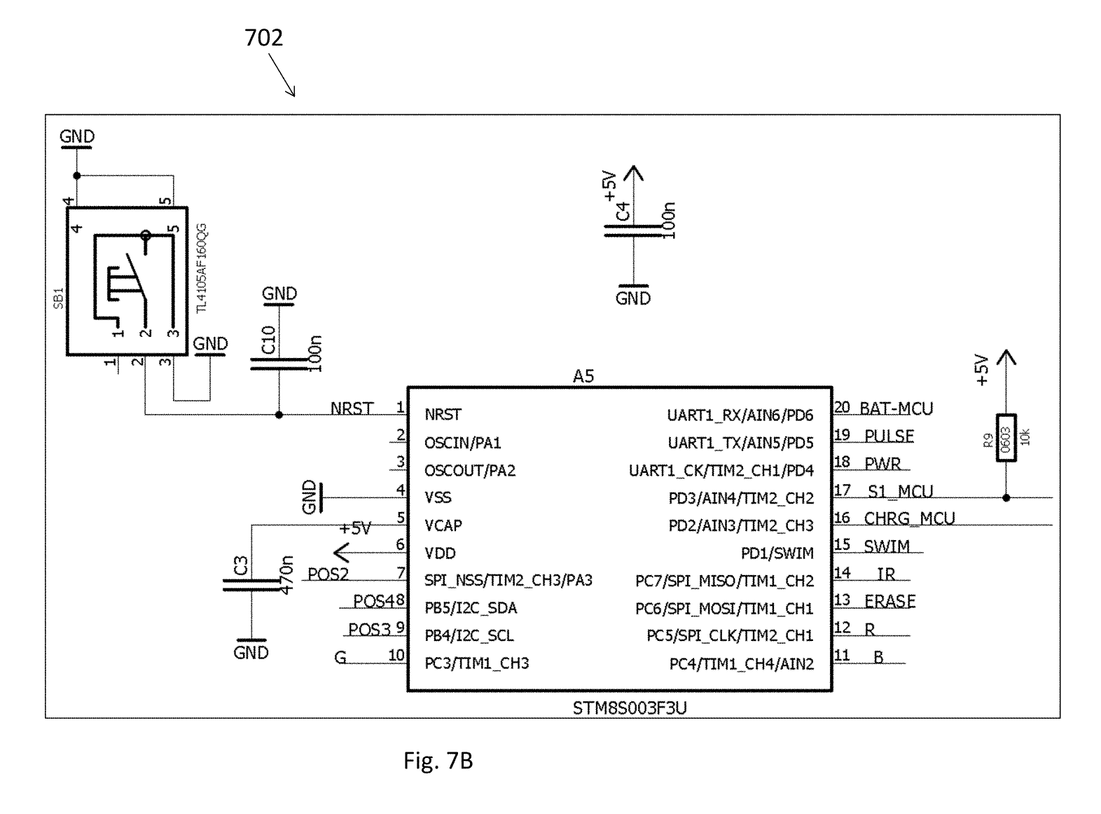

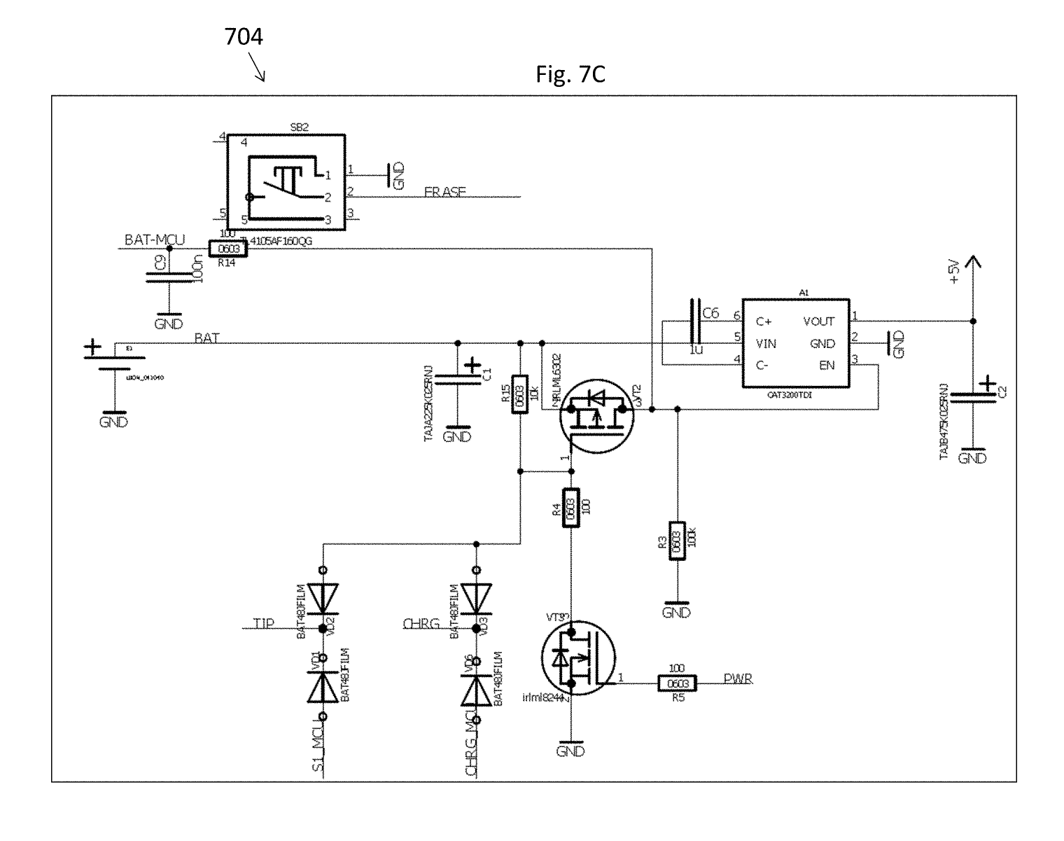

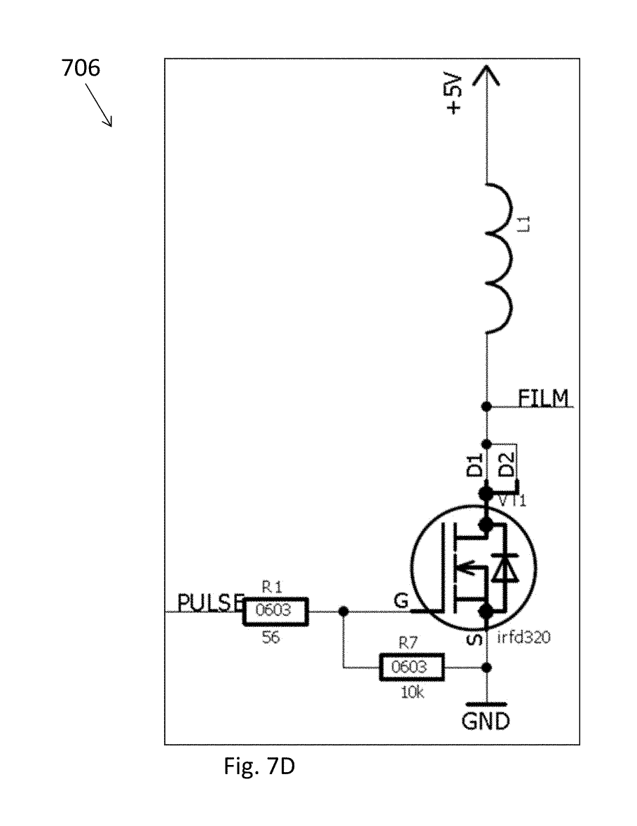

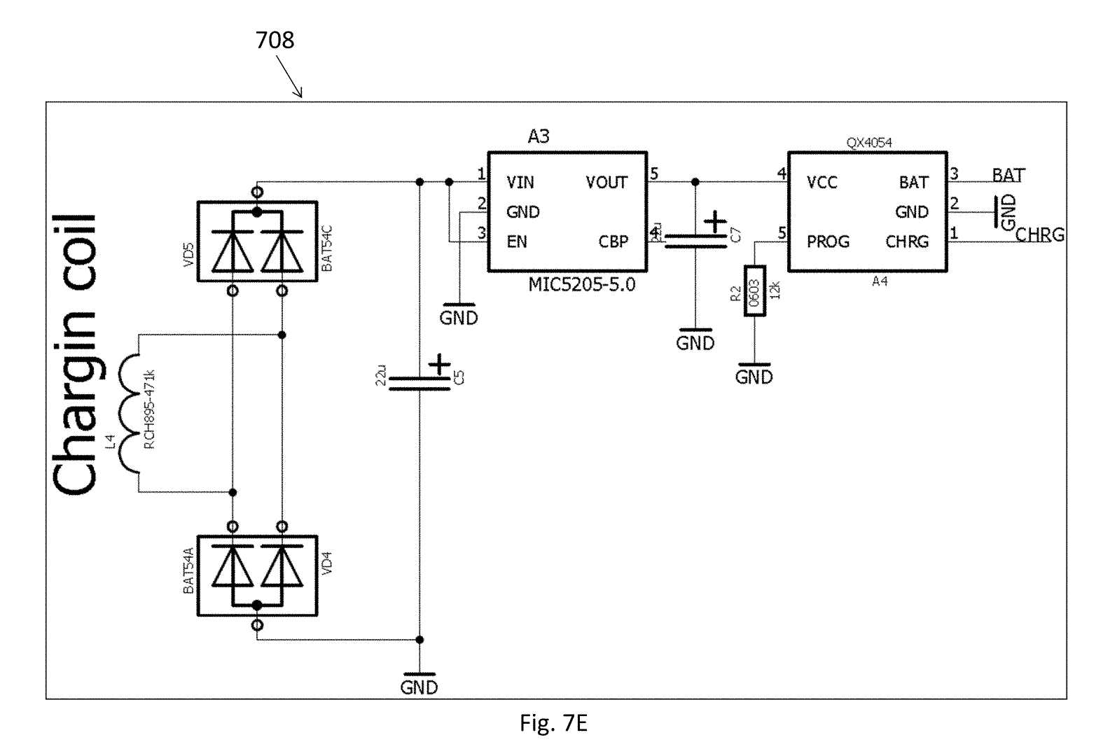

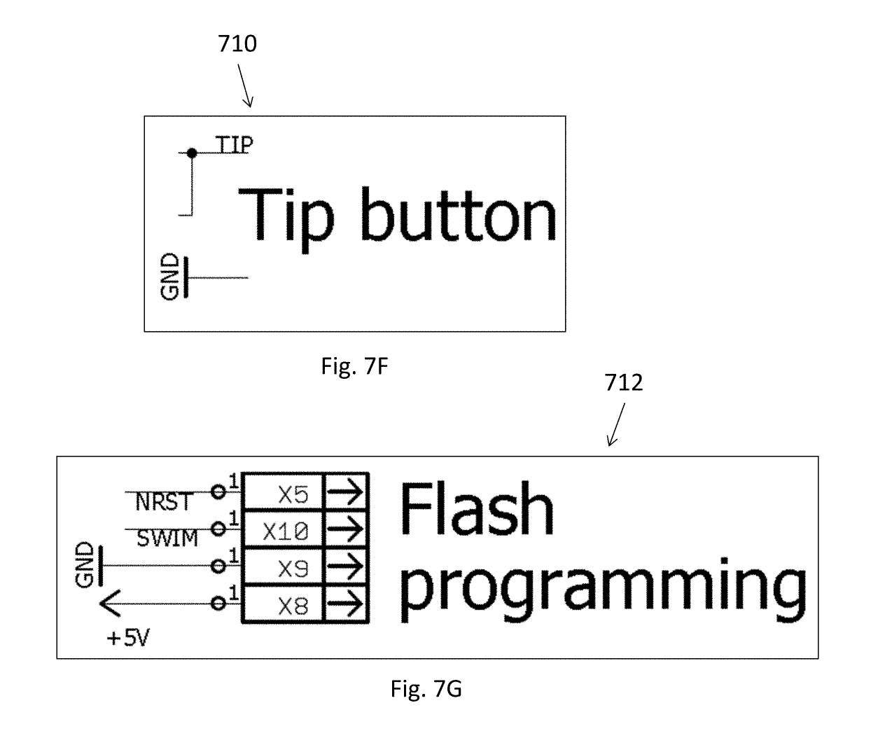

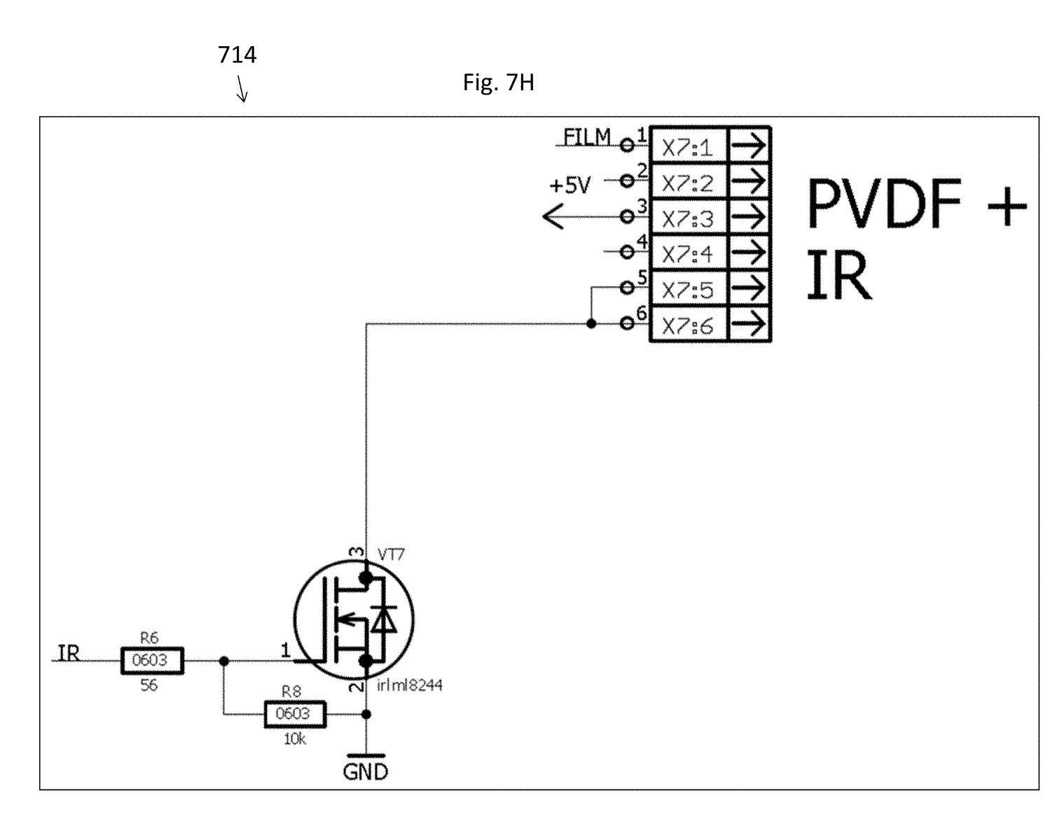

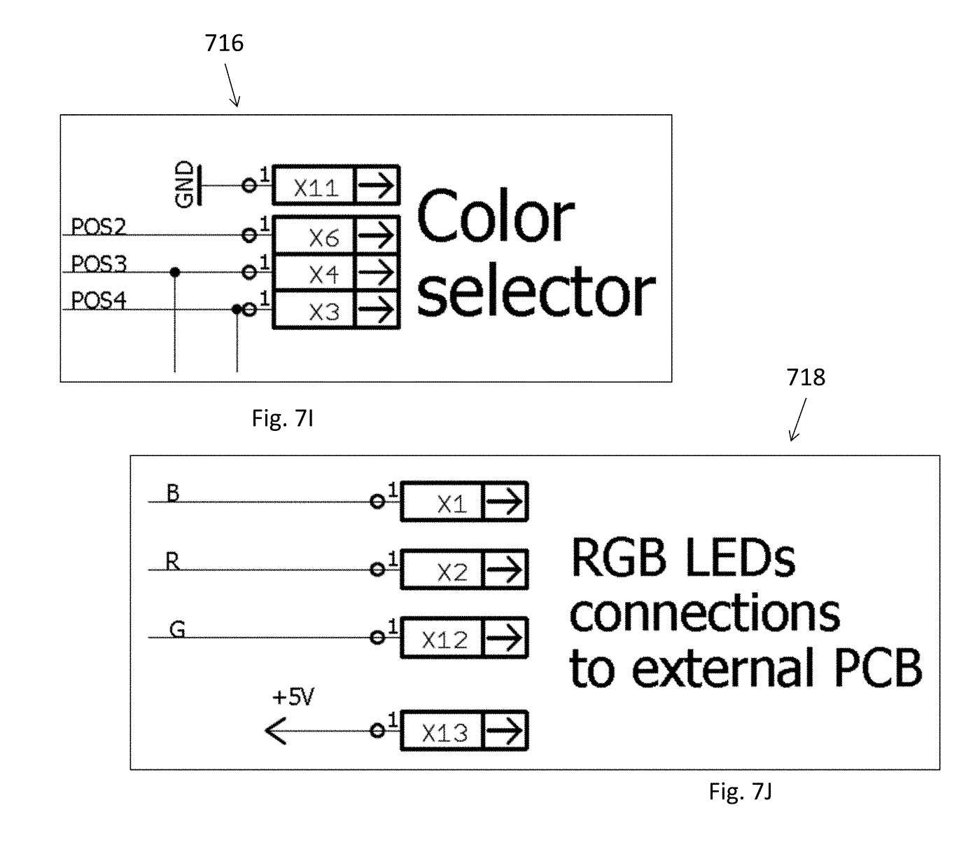

FIG. 7 is a circuit diagram illustrating components within an example virtual marker 102, in accordance with an implementation.

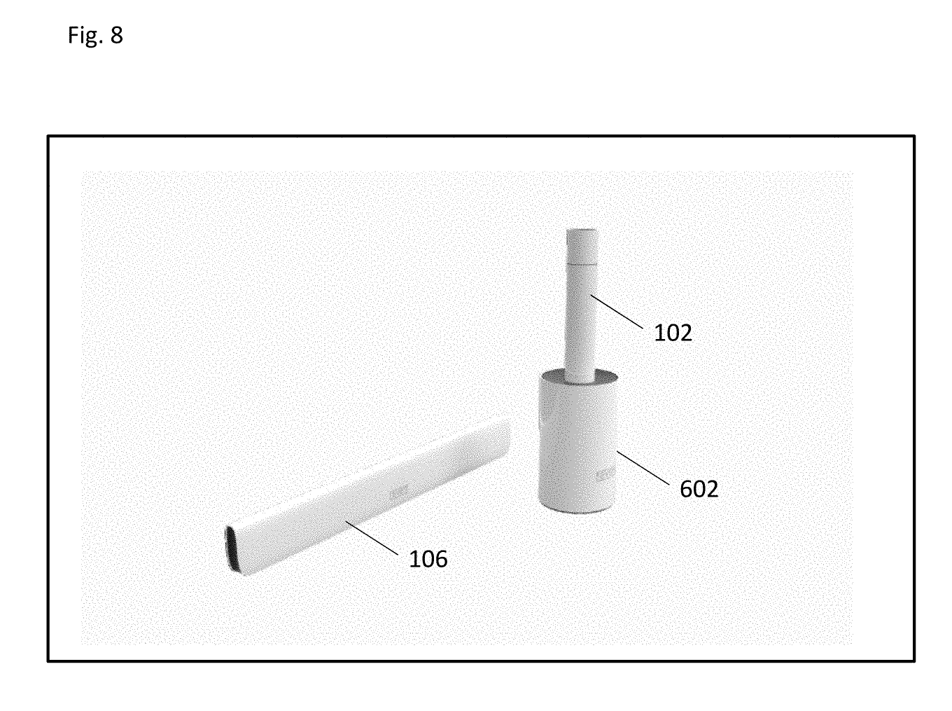

In one or more implementations, the virtual marker 102 is configured with a rechargeable battery and is bundled with a charging station 602 (FIG. 6), which can be a wireless or contactless charging device, as part of the power supply. In one non-limiting example, the virtual marker 102 can contact a wireless charging base for charging the power source of the virtual marker 102. For example, FIG. 8 illustrates a virtual marker 102 placed within contactless or wireless charging station 602. In one or more implementations, the charging station 602 can be connected to one another so as to form a serial or parallel power strip or link that provides a single USB, FIREWIRE, Lighting Connector, ESATA or other connections that distributes power to each of the charging stations. Additionally, the charging station 602 can function as a repository when the stylus is not in use. For example, the charging station 602 can be crafted to resemble an inkwell or other cylindrical repository formed to receive the stylus. However, the charging station 602 is not limited to such a design, and any other design capable of providing wireless charging as contemplated herein is suitable, such as a charging mat.

Without limitation to any theory or design of wireless power transmission, the charging station 602 can include a first induction coil that receives power to create an electromagnetic field within the charging station's 602 well. The virtual marker 102 can be configured to include a second induction coil that can take power provided by the electromagnetic field and covert such energy to electric current to charge the power source of the virtual marker. In this way, the induction coils function as an electrical transformer. The induction coils can be made of any suitable materials, such as silver plated copper or aluminum.

By emitting infrared light and ultrasonic sound, the virtual marker 102 simultaneously provides information relative to the position of the virtual marker 102 on the display device 104. In operation, this can be provided in response to an initial calibration procedure in which the virtual marker 102 is registered to specific points that are displayed on the output display device 104. For example, four points can be displayed on display device 104, and the user taps the virtual marker 102 on the respective points. As the user taps the virtual marker 102 on a point, the marker causes one or more infrared light emitting diodes (“I/R LEDs”) to emit and an ultrasonic transmitter to emit ultrasonic sound. In one or more implementations, a plurality of I/R LEDs are configured with the virtual marker 104 (e.g., 4 I/R LEDs) to increase output coverage, such as to a full 360°. The sensor component 106 can be configured with an infrared receiving module and an audio receiving module. The sensor component 106 can be further configured with a communications module, such as for BLUETOOTH or Wi-Fi connectivity. In one or more implementations, the audio receiving module includes two microphones that are each configured to detect ultrasonic audio frequencies and physically spaced apart within the sensor component 106. In one or more implementations, the infrared light functions as a synchronizing signal, and represents a starting time when light/sound signals are transmitted from the virtual marker 102. Thereafter, the ultrasonic sound is received first by the respective microphone positioned closest to the virtual marker 102, and second by the respective microphone positioned further away. The time values associated with the received infrared light, the first received ultrasonic sound signal and the second received ultrasonic sound signal are usable to provide a form of triangulation to represent the specific location of the virtual marker 102 relative to the display device 104. By registering the virtual marker 102 to respective positions on the display device 104 (e.g., points that are highlighted on the display device 104), the relative location of the virtual marker 102 can be calculated and a series of X/Y coordinates can be transmitted to or calculated by the computing device 108.

The following is an example formula for converting time differences of audio signals received by the first (e.g., “Left”) and second (e.g., “Right”) microphones in an example sensor component 106 into specific X/Y coordinates:

$$X coordinate = \frac{1}{2} \frac{\sqrt{\begin{matrix}- L {2}^{4} + 2 L {2}^{2} {LI}^{2} - {LI}^{4} + \\ 2 L {2}^{2} {a}^{2} + 2 {LI}^{2} {a}^{2} - {a}^{4}\end{matrix}}}{a}$$

$$Y coordinate = - \frac{1}{2} \frac{- L {2}^{2} + {LI}^{2}}{a}$$

$$where \text{:}$$

$$L 2 is distance to left microphone ;$$

$$L 1 is distance to right microphone ;$$

$$a is a parameter . Equal to distance between microphones ( mm ) ; and$$

$$L 1 and L 2 are calculated as time delay of ultrasonic signals relative to IR pulse multiplied by sound velocity .$$

In one or more implementations, the sensor component 106 can be configured with a processor configured by code executing therein to calculate X/Y coordinates, and further configured to wirelessly communicate the coordinates and other information to the computing device 108. For example, a series of bytes can be transmitted from the sensor component 108 to the computing device 106. 1. An example data format can include five bytes: {BYTE1, BYTE2, BYTE3, BYTE4, BYTES}. BYTE1 can be a bit field which contains information representing color and whether a tip of the virtual marker 102 is pressed or not. Example BYTE1 can include 8 bits,{Bit0, Bit1, Bit2, Bit3, Bit4, Bit5, Bit6, Bit7}, and representing: Bit0-Tip On/Off; Bit1, Bit2—Color. 00—Red, 01—Green, 10—Blue, 11—Wipe. Other bits may be simply unused. Continuing with this example, BYTE2 can represent the higher byte of the X coordinate, while BYTE3 represents the lower byte of the X coordinate. BYTE4 can represent the higher byte of the Y coordinate and BYTES can represent the lower byte of the Y coordinate. For example, the following five bytes are transmitted from the sensor component 106 to the computing device 108: {5, 31, 201, 19, 198}, in which the tip is depressed (e.g., is writing), color is blue, coordinates are X=31*256+201=8137 mm, Y=19*256+198=5062 mm.

Furthermore in operation, as coordinate information is received and/or calculated by the computing device 108, a conversion can take place to transform coordinates two pixels. An application executing on the computing device 108, for example, and that outputs video to the display device 104 can inform the computing device 108 of the respective resolution of the display device 104. Screen resolution information is usable to identify respective pixels relative to the calculated coordinates, and to simulate the drawing of the lines by the virtual marker 102.

Thus, light and sound signals emitted from the virtual marker 102 and received by a light receiver and a plurality of microphones configured in the sensor component 106 can be used for triangulation and determining the location of the virtual marker 102 at a point on the display device 104 as the virtual marker 102 traverses. The information can be transmitted by the sensor component 106 to a computing device 108, and the computing device 108 operating one or more software applications can display video or other content on the display device 104 substantially in real-time. In addition to displaying lines on the display device 104 (such as shown in FIGS. 2A and 2B), a graphical user interface can be provided on the display device 104 that includes graphical icons that are selectable as a function of the virtual marker 102 tapping thereon. By knowing the relative location of the virtual marker 102 on the display device 104 (e.g., X/Y coordinates and/or locations), virtually any user interface can be output to the display device 104 by the computing device 108 and input therein can be received, substantially in accordance with the teachings herein.

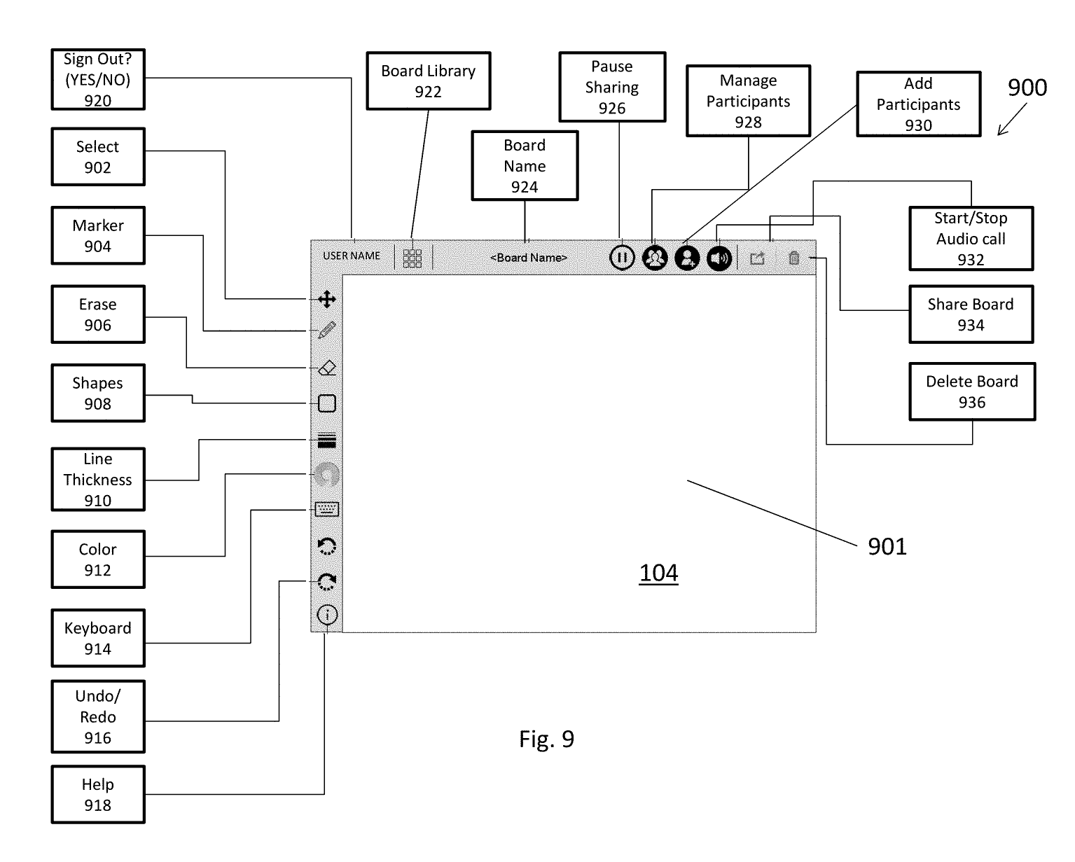

FIG. 9 illustrates an example graphical user interface provided to display device 104 in accordance with an example implementation. Of course, multitudes of other graphical user interfaces are supported in accordance with the teachings herein, and the example graphical user interface 900 illustrated in FIG. 9 is meant as but one non-limiting example. Respective icons are provided in a left vertical column of the display device 900 and in a top horizontal row of graphical user interface 900. In one or more implementations, the respective graphical user interface 900 is provided to a registered user who has successfully authenticated him or herself, and signed into the application. Username icon 902, when selected, enables a user to sign out of the process. Example select icon 904 provides selection functionality of lines provided in the workspace 901. Marker icon 906, when selected, results in the virtual marker 102 to operate as a writing device within workspace 901. Erase icon 908, when selected, results in the virtual marker 102 to operate as an eraser within workspace 901. Other options identified in the example graphical user interface 900 include shapes icon 910 for selecting and providing shapes within workspace 901, line thickness icon 912 defining a respective thickness of a line drawn by virtual marker 102, color icon 914 for defining a respective line color, keyboard icon 916 for causing a virtual keyboard to appear, undo/redo icon 918 to undo or redo a previous step, and help icon 924 accessing online help. At horizontal bar, board library 922 is provided to retrieve stored drawings or works previously developed in workspace 901 and board name 924 for defining a respective name for a current workspace 901. Icons 926 through 934 are usable in connection with conferencing and sharing contents, such as via pause sharing icon 926, manage participants icon 928, add participants icon 930, start and stop audio icon 932 and share board icon 934. Also remove a respective board developed in workspace 901.

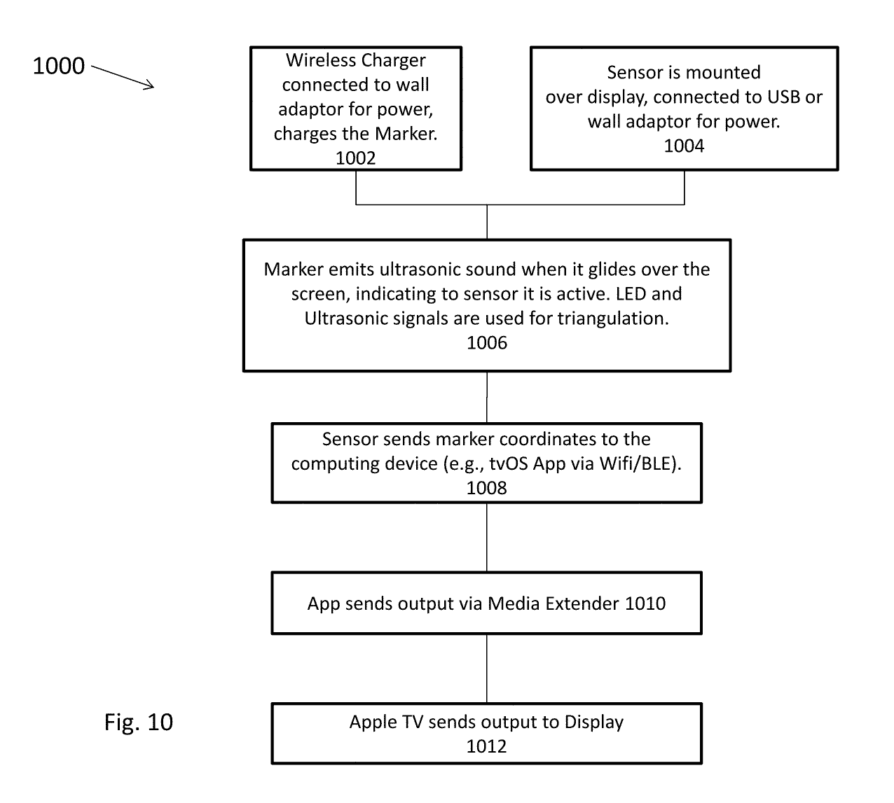

Turning now to FIG. 10, a flow diagram is described showing a routine 1000 that illustrates a broad aspect of a method for performing operations in accordance with at least one implementation disclosed herein. It should be appreciated that several of the logical operations described herein are implemented (1) as a sequence of computer implemented acts or program modules running on a communication device and/or (2) as interconnected machine logic circuits or circuit modules within a communication device. The implementation is a matter of choice dependent on the requirements of the device (e.g., size, energy, consumption, performance, etc.). Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 1002, and a wireless charger connected to a wall adaptor for power, charges the virtual marker 102. Further, the sensor component 106 is mounted over the display device 104, and powered for example via USB or wall adapter (step 1004). Alternatively, sensor component 106 can be configured with a rechargeable battery and be charged, including via a wireless charger, prior to use. At step 1006, the virtual marker 102 admits ultrasonic sound as it glides over the display device 104. This indicates to the sensor component 106 that the virtual marker 102 is active. Infrared light I/R LED and ultrasonic emissions are used to triangulate the for triangulation to determine the relative position of the virtual marker 102 on the display device 104. At step 1008, the sensor component 106 transmits the coordinates of the virtual marker 102 to the computing device 108 operating a software application (e.g., tvOS App) via BLUETOOTH (“BLE”) and/or Wi-Fi. At step 1010, video output is transmitted via a media extender, which sends the output to the display device screen 104 (step 1012).

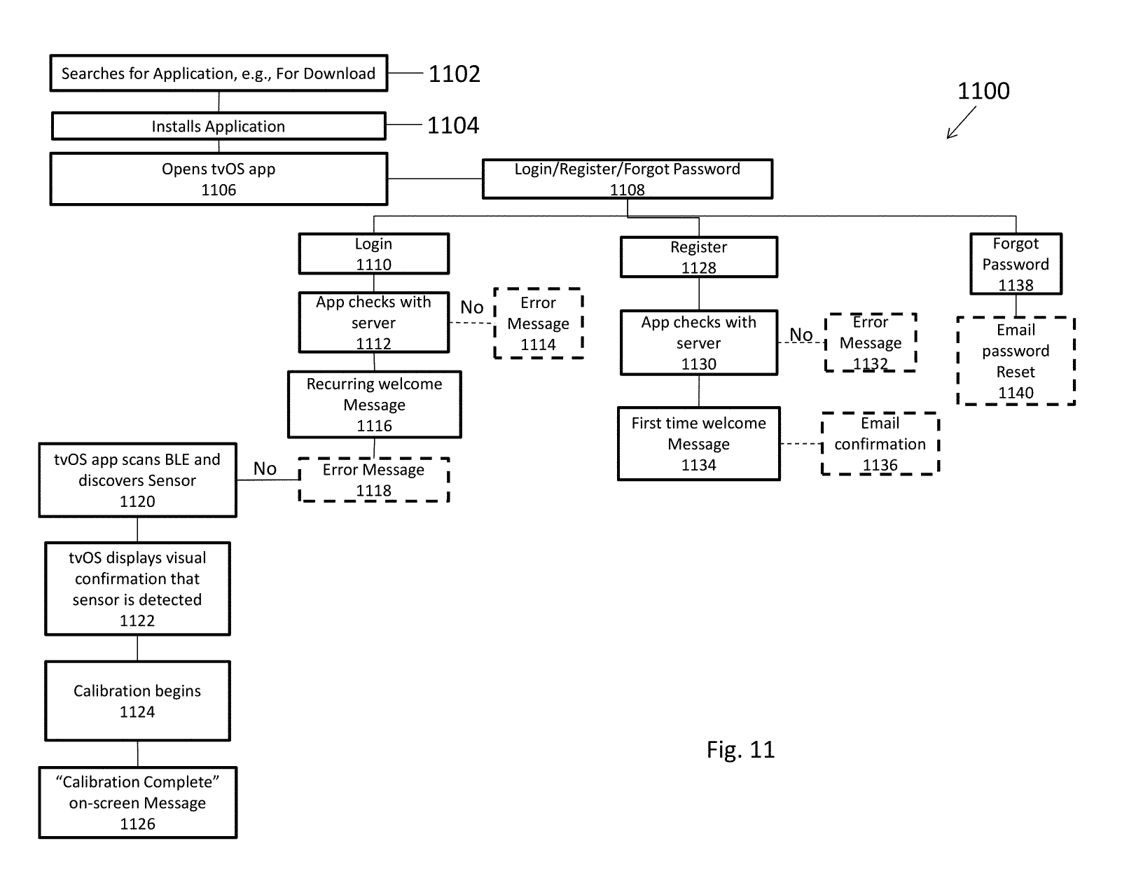

FIG. 11 is a flow diagram showing a routine 1100 that illustrates a broad aspect of operating a software application (e.g., tvOS), in connection with an example implementation. At step 1102, a search is conducted for a software application (e.g., tvOS App) to install on a computing device, such as a mobile computing device, a media extender, or other suitable hardware. At step 1104, the application is installed, and at step 1106 the application is launched on the respective computing device. At step 1108, a routine is executed for the user to login, register initially, or obtain his or her password in the event it is lost or forgotten. At step 1110, the user logs in, such as by submitting a username and password. An authentication process occurs at step 1112 and the application communicates with another computing device, such as a server computer (e.g., a respective computing device 112) located remotely, to check the user's credentials and confirm the user is authorized. If not, and error message appears at step 1114. If so, then a message is displayed, such as a recurring welcome (step 1116). In the event of some other error, such as related to connectivity, an error message may be displayed (step 1118). At step 1120, a Bluetooth or other wireless protocol scan occurs and the sensor component 106 is discovered and communications with sensor component 106 are implemented. At step 1122, a visual confirmation is displayed that the sensor component 106 is detected and a calibration process, such as described herein, begins (step 1124). Upon successful calibration, the calibration a messages displayed representing the calibration is complete (step 1126).

In the event that a user has not yet registered and, accordingly, is not authorized to operate the application executing on the computing device, a registration process occurs at step 1128. During the registration process, communication between the computing device operating the software application and another device, such as a server computer, takes place to complete the process (step 1130). For example, a problem may occur, such as a username already being used, a password does not comply conform to a pre-determined standard, or virtually with any other registration step. In such case, an error message may be transmitted at step 1134 that represents the problem. If no error occurs, then a welcome message is provided at step 1132, and an email confirmation is transmitted at 1136. In the event that a user has already registered but has lost or forgotten his or her password, then, at step 1138, a process occurs for the user to have an his or her password reset or provided, such as by email password reset process in step 1140.

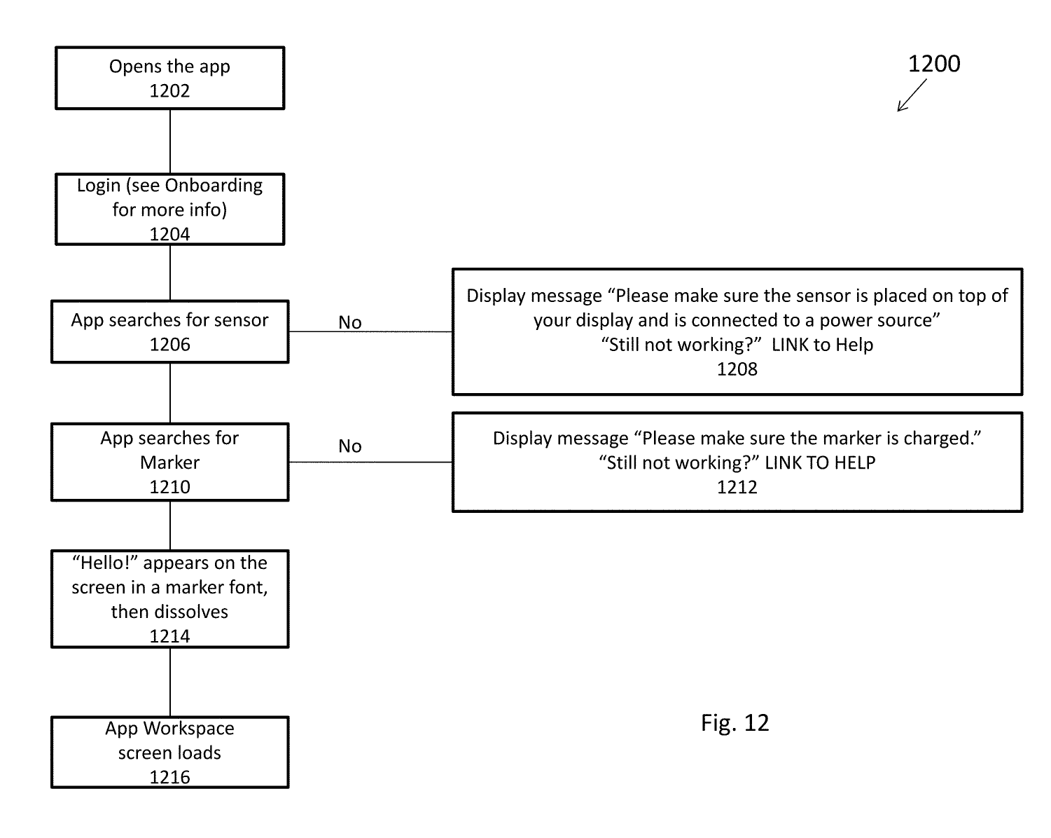

FIG. 12 is a flow diagram showing a routine 1200 that illustrates a broad aspect of operating a software application (e.g., tvOS), in connection with an example implementation. In the example shown in FIG. 12, at step 1202 a user launches the software application executing on the computing device 108, and at step 1204, the user logs in (such as shown and described above with reference to FIG. 11). At step 1206, the computing device 108 executing the software application searches for the sensor component 106 and, if not found, a message is displayed at step 1208 prompting the user to move the sensor to a location relative to a display device 104 and is powered. If the sensor component 106 is found, then at step 1210 the computing device 108 executing the software application searches for the virtual marker 102 and, if not found, a message is displayed at step 1212 prompting the user to ensure the marker is powered. In one implementation, the user taps the virtual marker 102 to initiate emission of I/R light and ultrasonic sound to be received by the sensor component 106, which transmits to the computing device 108, thereby indicating the virtual marker 102 can be “seen” by the computing device 108. At step 1214, a message, such as formatted as video, is displayed on the display device 104, and a user interface, such as graphical user interface 1100, is displayed. As shown and described herein, a canvas or work screen (including referred to herein, generally, a “board”) on the display device 104. The canvas is generated by the computing device and is updatable at least indirectly in response to output from the virtual marker 102.

The present application provides an improvement to the functioning of computing devices by allowing a user to simulate drawing onto a display device that is not formatted to receive input, such as a non-interactive display. In one or more implementations, the computing device can send or transmit, through local or remote data channels using common networking protocols, the data relating to the current state of the canvas as well as the data initiated by a virtual marker 102 to a second computing device or remote computing platform 106. This remote computing platform can be connected to a secondary display device and used to update display in real time so as to simulate the effect of the virtual marker 102 being used directly on that respective screen. In this way, individuals in remote locations can collaboratively use their display devices to work on a single canvas while each user's input is captured and displayed to all collaborators in real time.

Moreover, computing devices 108 can communicate with data processing apparatuses using data connections, which are respectively coupled to communication network. Communication network 110 can be any communication network, but is typically the Internet or some other global computer network. Data connections can be any known arrangement for accessing communication network , such as the public Internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

One or more of respective devices 102, 104, 106, 108 and 112 can be configured with memory can be which is coupled to microprocessor(s). The memory may be used for storing data, metadata, and programs for execution by the microprocessor(s). The memory may include one or more of volatile and non-volatile memories, such as Random Access Memory (“RAM”), Read Only Memory (“ROM”), Flash, Phase Change Memory (“PCM”), or other type. The devices can include an audio input/output subsystem, which may include one or more microphones and/or speakers. One or more of respective devices 102, 104, 106, 108 and 112 can be configured to include one or more wireless transceivers, such as an IEEE 802.11 transceiver, an infrared transceiver, a BLUETOOTH transceiver, a wireless cellular telephony transceiver (e.g., 1G, 2G, 3G, 4G), or another wireless protocol to connect the data processing system with another device, external component, or a network. In addition, Gyroscope/Accelerometer can be provided.

One or more of respective devices 102, 104, 106, 108 and 112 can also be configured to include one or more input or output (“I/O”) devices and interfaces which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to one or more of the respective devices

It will be apparent from this description that aspects of the application may be embodied, at least in part, in software. That is, the computer-implemented methods may be carried out in a computer system or other data processing system in response to its processor or processing system executing sequences of instructions contained in a memory, such as memory or other machine-readable storage medium. The software may further be transmitted or received over a network (not shown) via a network interface device. In various implementations, hardwired circuitry may be used in combination with the software instructions to implement the present implementations. Thus, the techniques are not limited to any specific combination of hardware circuitry and software, or to any particular source for the instructions.

In one or more implementations, the present application provides improved processing techniques to prevent packet loss, to improve handling interruptions in communications, to reduce or eliminate latency and other issues associated with wireless technology. For example, in one or more implementations Real Time Streaming Protocol (RTSP) can be implemented, for example, for sharing output associated with a camera, microphone and/or other output devices configured with a computing device. In addition to RTSP, one or more implementations of the present application can be configured to use Web Real-Time Communication (“WebRTC”) to support browser-to-browser applications.

In one implementation WebRTC is shown with regard to communications between user computing devices 108 (such as a CHROME BOOK and mobile computing device, e.g., a smart phone) and supporting browser-to-browser applications and P2P functionality. In addition, RTSP is utilized in connection with user computing devices 108 and/or an Internet media extender, thereby enabling presentation of audio/video content from devices 108 on television 104.

In one or more implementations, the computing device 108 is configured to save each respective X/Y coordinate, including by transmitting the information to a remote storage device. The information can be saved as an array of coordinates over time, thereby enabling reproduction of respective “drawings” or output from the virtual marker 102 to be displayed on a display device 104 in the future.

In one or more implementations of the present patent application, a processor configured with code processes information representing a selection event that occurred in the display unit. For example, a user makes a selection in a remote control software application operating on his or her mobile computing device (e.g., iPhone) in a portion of the display unit while the interactive media content in the display unit is provided therein. The processing that occurs can be to determine at least a relative time and location of the selection event that occurred in the second portion of the display. The information representing the selection event can be stored in one or more databases that are accessible to at least one computing device. The selection of an item can be processed to enable the interaction with at least a portion of the interactive media content at one of the remote devices associated with the selection event. This enables results of a respective interaction associated with the selection event to be viewable or otherwise provided at one particular remote device, but not viewable or otherwise provided at other of the remote devices.

While this specification contains many specific implementation details, these should not be construed as limitations on the scope of any implementation or of what can be claimed, but rather as descriptions of features that can be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular implementations of the subject matter described in this specification have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing can be advantageous.

Publications and references to known registered marks representing various systems are cited throughout this application, the disclosures of which are incorporated herein by reference. Citation of the above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred implementation thereof, it will be understood by those skilled in the art that various changes in form and details may be made therein without departing from the spirit and scope of the invention.

What is claimed is:

1. A system for displaying content on an electronic display device, the system comprising:
a computing device having at least one processor configured by executing code stored on non-transitory processor readable media;
an electronic display device configured to display content received directly or indirectly from the computing device;
a wireless output device configured to emit light signals and sound signals in response to an actuation of the wireless output device; and
a sensor component configured with a light receptor to receive the light signals, a sound receptor to receive the audio signals, and a communications module configured to communicate with the computing device,
wherein the light signals and sound signals from the wireless output device are received by the sensor component and usable to determine a respective location of the wireless output device relative to output of the electronic display device, and further wherein the computing device uses the respective location to generate output received by the electronic display device to simulate the wireless output device operating as a writing device as a function of the generated output.

2. The system of claim 1, wherein at least one of the light signals is received by the sensor component prior to receiving at least one of the audio signals, and further wherein the respective location of the wireless output device is determined at least in part as a function of the difference between a time of receiving the at least one light signal and the time of receiving the at least one sound signal.

3. The system of claim 2, wherein the sensor component is configured with at least two microphones, and further wherein the respective location of the wireless output device is determined at least in part as a function of the difference between a time of receiving the at least one sound signal by a first microphone and a time of receiving the at least one sound signal by a second microphone.

4. The system of claim 1, wherein the wireless output device is configured with a switch and a stylus portion having a tip, wherein actuating the tip switches the wireless output device to output the light signals and the sound signals.

5. The system of claim 1, wherein the output represents a simulated line drawn by the wireless output device.

6. The system of claim 1, wherein the wireless output device is configured in the shape of a writing implement.

7. The system of claim 1, wherein the electronic display device is a television, a monitor.

8. The system of claim 1, wherein the output generated by the computing device is video.

9. The system of claim 1, wherein the output generated by the computing device is stored for future access.

10. The system of claim 1, wherein the audio signals are ultrasonic and the light signals are infrared.

11. A method for displaying content on an electronic display device, the method comprising:
executing, by at least one processor configured in a computing device, code stored on non-transitory processor readable media;
receiving and displaying content received directly or indirectly from the computing device, content;
emitting, by a wireless output device, light signals and sound signals in response to an actuation of the wireless output device;
receiving, by a sensor component the light signals and the audio signals;
wherein the light signals and sound signals from the wireless output device are received by the sensor;
determining, by the sensor component or the computing device, a respective location of the wireless output device relative to output of the electronic display device as a function of the received light signals and sound signals; and
generating, by the computing device, output as a function of the respective location of the wireless output device; and
simulating the wireless output device to be operating as a writing device as a function of the generated output.

12. The method of claim 11, wherein at least one of the light signals is received by the sensor component prior to receiving at least one of the audio signals, and further wherein the respective location of the wireless output device is determined at least in part as a function of the difference between a time of receiving the at least one light signal and the time of receiving the at least one sound signal.

13. The method of claim 12, wherein the sensor component is configured with at least two microphones, and further wherein the respective location of the wireless output device is determined at least in part as a function of the difference between a time of receiving the at least one sound signal by a first microphone and a time of receiving the at least one sound signal by a second microphone.

14. The method of claim 11, wherein the wireless output device is configured with a switch and a stylus portion having a tip, wherein actuating the tip switches the wireless output device to output the light signals and the sound signals.

15. The method of claim 11, wherein the output represents a simulated line drawn by the wireless output device.

16. The method of claim 11, wherein the wireless output device is configured in the shape of a writing implement.

17. The method of claim 11, wherein the electronic display device is a television, a monitor.

18. The method of claim 11, wherein the output generated by the computing device is video.

19. The method of claim 1, further comprising storing, by the computing device, the output generated by the computing device for future access.

20. The method of claim 1, wherein the audio signals are ultrasonic and the light signals are infrared.
